(19) United States
(12) Patent Application Publication
(10) Pub. No.: US 2025/0029369 A1
(43) Pub. Date: Jan. 23, 2025

(54) IMAGE RESTORATION METHOD AND DEVICE, AND NON-TRANSITORY COMPUTER STORAGE MEDIUM

(71) Applicant: BOE Technology Group Co., Ltd., Beijing (CN)

(72) Inventor: Mengdi SUN, Beijing (CN)

(73) Assignee: BOE Technology Group Co., Ltd., Beijing (CN)

(21) Appl. No.: 18/281,570

(22) PCT Filed: Sep. 30, 2022
(86) PCT No.: PCT/CN2022/123334

§ 371 Date: Sep. 12, 2023

(51) Int. Cl. G06V 10/771; G06T 5/30; G06T 5/50; G06V 10/25; G06V 10/44; G06V 10/80

(52) U.S. Cl. CPC G06V 10/771; G06T 5/30; G06T 5/50; G06V 10/25; G06V 10/44; G06V 10/806; G06T 2207/20221

(57) ABSTRACT

Disclosed are an image restoration method and device, and a non-transitory computer storage medium. The image restoration method includes: an original mask in an original to-be-restored image is processed into a dilated mask with a regular shape, the dilated mask is overlaid at the location of the original mask in the original to-be-restored image to acquire a mask enhancement feature map, and then the dilated mask in the mask enhancement feature map is restored using an image restoration network to acquire a restored image corresponding to the original to-be-restored image.

### CROSS-REFERENCE TO RELATED APPLICATION

This application is a U.S. national stage of international application No. PCT/CN2022/123334, filed on Sep. 30, 2022, the disclosure of which is herein incorporated by reference in its entirety.

### TECHNICAL FIELD

The present disclosure relates to the field of image technologies, and in particular, to an image restoration method and device, and a non-transitory computer storage medium.

### BACKGROUND

Image restoration refers to an image processing technology that reconstructs a lost or damaged part of an image, for example, restoring a mask or flaw in an old photo.

### SUMMARY

Embodiments of the present disclosure provide an image restoration method and device, and a non-transitory computer storage medium. The technical solutions are as follows.

According to an aspect of the present disclosure, an image restoration method is provided. The image restoration method includes;
acquiring an original to-be-restored image;
performing mask detection on the original to-be-restored image;
acquiring an original mask feature map of the original to-be-restored image in response to detecting an original mask in the original to-be-restored image;
acquiring a dilated mask feature map by processing the original mask in the original mask feature map into a dilated mask, wherein the dilated mask includes at least one mask unit, and the original mask is located in an area in which the at least one mask unit is located;
acquiring a mask enhancement feature map by overlaying the dilated mask in the dilated mask feature map at the location of the original mask in the original to-be-restored image; and
acquiring a restored image corresponding to the original to-be-restored image by inputting the mask enhancement feature map into an image restoration network to restore the dilated mask in the mask enhancement feature map.

In some embodiments, acquiring the dilated mask feature map by processing the original mask in the original mask feature map into the dilated mask includes:
acquiring a target area, where the target area includes a pixel point of the original mask in the original mask feature map;
traversing the target area by a detection box; and
acquiring the dilated mask feature map by processing a plurality of pixel points in the detection box into the mask unit in response to detecting that the pixel point of the original mask is present in the detection box, wherein a pixel value of the pixel point in the mask unit is a preset value.

In some embodiments, the detection box is a square detection box, and a moving step length during traversal of the detection box is equal to a side length.

In some embodiments, the mask enhancement feature map includes a dilated mask feature and an original image feature except an area in which the dilated mask feature is located.

Acquiring the restored image corresponding to the original to-be-restored image by inputting the mask enhancement feature map into the image restoration network to restore the dilated mask in the mask enhancement feature map includes:
acquiring a restoration feature map by fusing the original image feature and the dilated mask feature in the mask enhancement feature map through the image restoration network to restore the dilated mask in the mask enhancement feature map.

In some embodiments, after acquiring the restoration feature map, the image restoration method includes:
performing dimension transformation on the restoration feature map to acquire the restored image corresponding to the original to-be-restored image.

In some embodiments, the image restoration network includes a plurality of feature fusion groups (FFG).
acquiring a restoration feature map by fusing the original image feature and the dilated mask feature in the mask enhancement feature map through the image restoration network to restore the dilated mask in the mask enhancement feature map includes:
performing feature extraction on the mask enhancement feature map to acquire a global feature map;
acquiring a local restoration feature map by fusing the original image feature and the dilated mask feature in the global feature map through the plurality of FFGs; and
acquiring the restoration feature map by merging the global feature map and the local restoration feature map.

In some embodiments, the plurality of FFGs include a first FFG, a plurality of second FFGs, and a third FFG. Each of the first FFG, the plurality of second FFGs, and the third FFG includes a plurality of multi-attention blocks (MAB).
acquiring the local restoration feature map by fusing the original image feature and the dilated mask feature in the global feature map through the plurality of FFGs includes:
acquiring a first feature map by performing down-sampling on the global feature map;
acquiring a second feature map by fusing the dilated mask feature and the original image feature in the first feature map through the first FFG;
acquiring a third feature map by performing down-sampling on the second feature map;
acquiring a fourth feature map by fusing the dilated mask feature and the original image feature in the third feature map many times through the plurality of second FFGs;
acquiring a fifth feature map by performing up-sampling on the fourth feature map;
acquiring a sixth feature map by merging the first feature map and the fifth feature map, and inputting the merged first feature map and fifth feature map into the third FFG; and
acquiring the local restoration feature map by performing up-sampling on the sixth feature map

In some embodiments, the MAB includes a first image enhancement network and a second image enhancement network. The image restoration method further includes:
inputting a to-be-processed image into the MAB;
acquiring a first enhanced image by inputting the to-be-processed image into the first image enhancement network;
acquiring a second enhanced image by inputting the to-be-processed image into the second image enhancement network;
acquiring a first intermediate image by performing feature fusion on the first enhanced image and the to-be-processed image; and
acquiring a feature-enhanced image by performing feature fusion on the first intermediate image and the second enhanced image.

The first image enhancement network includes a plurality of convolutional layers, a plurality of depth-separable convolutional layers, and a pooling layer.

The second image enhancement network includes one convolutional layer and one depth-separable convolutional layer.

The first image enhancement network and the second image enhancement network are defined to dilate a receptive field of the to-be-processed image, where a receptive field dilation capability of the first image enhancement network is stronger than that of the second image enhancement network.

In some embodiments, the image restoration network is trained by:
acquiring a training data set, where the training data set includes an original to-be-restored image and a training sample, the original to-be-restored image is provided with a mask, and the training sample is an image with complete image content;
processing the original mask in the original mask feature map into the dilated mask;
overlaying the dilated mask at a partial area in the training sample to acquire a sample mask enhancement feature map;
inputting the sample mask enhancement feature map into a to-be-trained image restoration network to restore the dilated mask in the sample mask enhancement feature map and acquire a restored image corresponding to the training sample;
comparing the restored image corresponding to the training sample with the training sample to acquire a comparison difference;
adjusting the to-be-trained image restoration network based on the comparison difference and performing the step of processing the original mask in the original mask feature map into the dilated mask in response to that the comparison difference is greater than a preset result; and
determining the to-be-trained image restoration network as the image restoration network in response to the comparison difference being less than or equal to the preset result.

In some embodiments, the dilated mask sample includes a plurality of the dilated masks, and sizes of any two of the plurality of dilated masks are different.

In some embodiments, a loss function of the image restoration network includes:

$$Loss = {‖ \hat{I} - {I}_{gt} ‖}_{1}$$

where Loss represents the comparison difference, Î represents the restored image corresponding to the training sample, and I_{gt} represents the training sample.

In some embodiments, the preset value is 0.

Acquiring the mask enhancement feature map by overlaying the dilated mask in the dilated mask feature map at the location of the original mask in the original to-be-restored image includes:
acquiring the mask enhancement feature map by multiplying the dilated mask feature map by the original to-be-restored image, wherein a pixel value of a pixel point of the dilated mask in the acquired mask enhancement feature map is 0.

According to another aspect of the present disclosure, an image restoration device is provided. The image restoration device includes a processor and a memory. The memory stores at least one instruction, at least one program, a code set, or an instruction set thereon. The processor, when loading and executing the at least one instruction, the at least one program, the code set, or the instruction set, is caused to perform the foregoing image restoration method.

According to still another aspect of the present disclosure, a non-transitory computer storage medium is provided. The non-transitory computer storage medium stores at least one instruction, at least one program, a code set, or an instruction set thereon. The at least one instruction, the at least one program, the code set, or the instruction set, when loaded and executed by a processor, causes the processor to perform the foregoing image restoration method.

### BRIEF DESCRIPTION OF THE DRAWINGS

For clearer descriptions of the technical solutions according to the embodiments of the present disclosure, the drawings required to be used in the description of the embodiments are briefly introduced below. It is obvious that the drawings in the description below are only some embodiments of the present disclosure, and it is obvious for those skilled in the art that other drawings can be obtained according to the drawings without creative efforts.

FIG. 1 is a flowchart of an image restoration method according to some embodiments of the present disclosure;

FIG. 2 is a flowchart of another image restoration method according to some embodiments of the present disclosure;

FIG. 3 is a schematic diagram of a network structure of a mask detection network according to some embodiments of the present disclosure;

FIG. 4 is a schematic diagram of a network structure of a part of modules in the mask detection network shown in FIG. 3;

FIG. 5 is a schematic diagram of a structure of traversing a target area by a detection box according to some embodiments of the present disclosure;

FIG. 6 is a network architecture diagram of processing an original mask into a dilated mask according to some embodiments of the present disclosure;

FIG. 7 is a network architecture diagram of image restoration according to some embodiments of the present disclosure;

FIG. 8 is a flowchart of acquiring a restoration feature map according to some embodiments of the present disclosure;

FIG. 9 is a schematic diagram of a network structure of an image restoration network according to some embodiments of the present disclosure;

FIG. 10 is a schematic diagram of a network structure of an FFG according to some embodiments of the present disclosure;

FIG. 11 is a schematic diagram of a network structure of an MAB according to some embodiments of the present disclosure;

FIG. 12 is a schematic diagram of an image restoration process according to some embodiments of the present disclosure;

FIG. 13 is a network architecture diagram of training an image restoration network according to some embodiments of the present disclosure;

FIG. 14 is a flowchart of training an image restoration network according to some embodiments of the present disclosure;

FIG. 15 is a structural block diagram of an image restoration apparatus according to some embodiments of the present disclosure.

The foregoing drawings show the explicit embodiments of the present disclosure, which will be described below in detail. These drawings and text descriptions are not intended to limit the scope of the conception of the present disclosure in any way, but to illustrate the concept of the present disclosure to those skilled in the art with reference to specific embodiments.

### DETAILED DESCRIPTION

For clearer descriptions of the objects, technical solutions, and advantages of the present disclosure, the embodiments of the present disclosure are further described in detail below with reference to the drawings.

An image restoration method in some practices includes: an original to-be-restored image is first acquired, then original masks and an original image in the original to-be-restored image are marked to acquire a marked intermediate feature map, and the intermediate feature map is input into an image restoration network to perform feature fusion on the original masks and the original image to acquire a restored image.

However, in the foregoing method, as patterns of the masks in the photo are greatly different, an image restoration effect is poor.

First, an application scenario related to the embodiments of the present disclosure is described.

Image restoration technology refers to an image processing technology for acquiring a complete image by restoring a pixel feature of a damaged part in an incomplete image. For example, the image restoration technology is defined to remove an unwanted target in an image, restore a damaged part in an image, and the like. The image restoration technology includes an image restoration method based on machine learning.

Machine learning, a branch of artificial intelligence, refers to using a computer as a tool and learning representations of various things in the real world from big data, where the representations are directly used for computer calculation. In the field of image technologies, machine learning is applicable to target detection, image generation, image segmentation, and other aspects. Artificial intelligence refers to a technology for studying principles and implementation methods of various intelligent machines and enabling the machines to have perception, reasoning, and decision-making functions.

For example, a photo may be damaged over time, as a result, an old photo becomes shabby and blurry; for example, a plurality of masks are present in the photo, as a result, the photo is not complete and clear. The image processing technology may restore the damaged photo to acquire a clear and complete photo.

It should be noted that the application scenario described in the embodiments of the present disclosure is intended to describe the technical solutions in the embodiments of the present disclosure more clearly, but does not constitute a limitation on the technical solutions provided in the embodiments of the present disclosure. Those of ordinary skill in the art may learn that the technical solutions provided in the embodiments of the present disclosure are also applicable to a similar technical problem.

An implementation environment includes a photo, a shooting assembly, a server, and a display terminal. The shooting assembly includes a camera that is defined to shoot a real photo as a digital image. The server includes a processor. The server may establish a wired or wireless connection with the shooting assembly to generate a restored image based on an image captured by the shooting assembly and display the restored image on the display terminal.

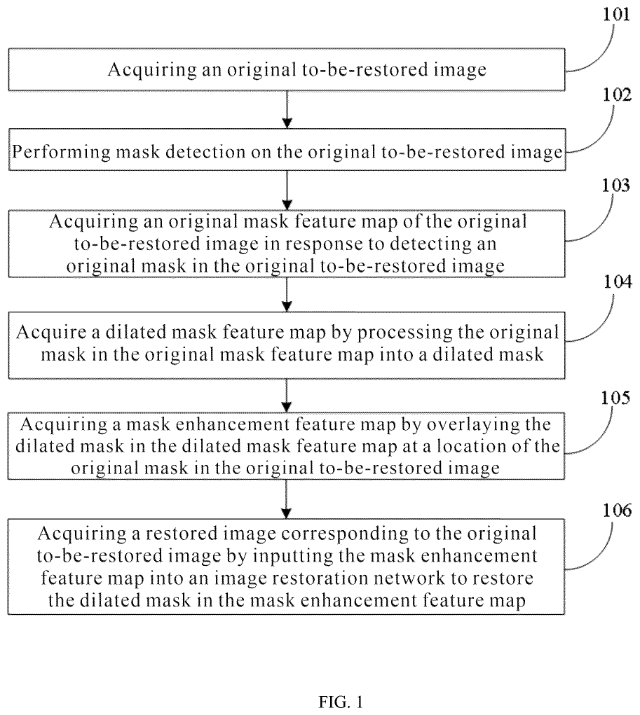

FIG. 1 is a flowchart of an image restoration method according to some embodiments of the present disclosure. The image restoration method is applicable to the server of the foregoing implementation environment. The image restoration method includes the following steps.

In step 101, an original to-be-restored image is acquired.

In step 102, mask detection is performed on the original to-be-restored image.

In step 103, an original mask feature map of the original to-be-restored image is acquired in response to detecting an original mask in the original to-be-restored image.

In step 104, the original mask in the original mask feature map is processed into a dilated mask to acquire a dilated mask feature map.

The dilated mask includes at least one mask unit, and the original mask is located in an area in which the at least one mask unit is located.

In step 105, the dilated mask in the dilated mask feature map is overlaid at the location of the original mask in the original to-be-restored image to acquire a mask enhancement feature map.

In step 106, the mask enhancement feature map is input into an image restoration network to restore the dilated mask in the mask enhancement feature map and acquire a restored image corresponding to the original to-be-restored image.

In summary, the embodiments of the present disclosure provide an image restoration method. An original mask in an original to-be-restored image is processed into a dilated mask with a regular shape, and the dilated mask is overlaid at the location of the original mask in the original to-be-restored image to acquire a mask enhancement feature map; then the dilated mask in the mask enhancement feature map is restored using an image restoration network to acquire a restored image corresponding to the original to-be-restored image. As the shape of the dilated mask is regular, the effect of restoring the mask in the original image is improved, the problem of a poor restoration effect of the restored image in the related art is solved, thereby improving the restoration effect of the restored image.

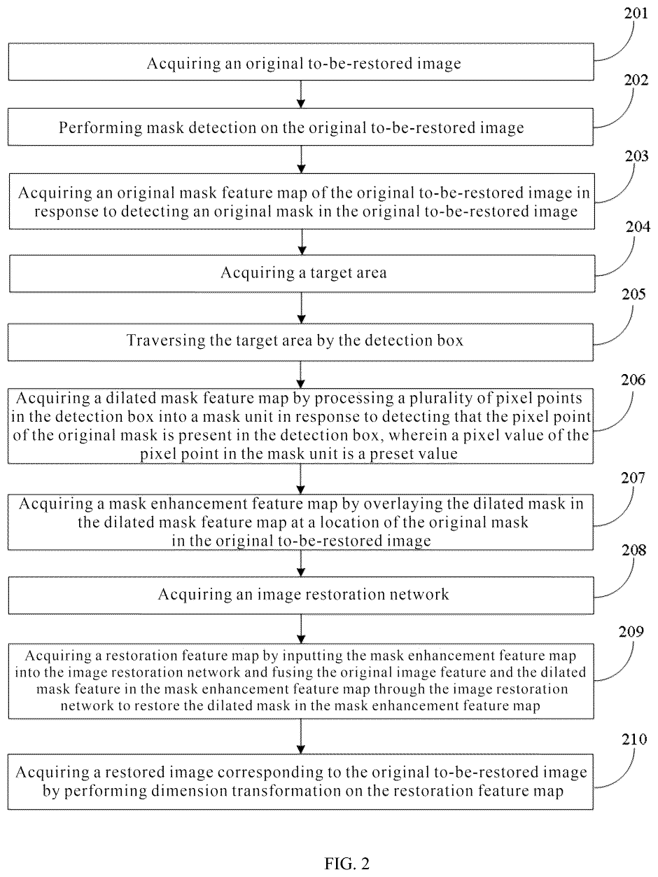

FIG. 2 is a flowchart of another image restoration method according to some embodiments of the present disclosure. The image restoration method is applicable to the server of the foregoing implementation environment. The image restoration method includes the following steps.

In step 201, an original to-be-restored image is acquired.

The original to-be-restored image includes an image that has an image restoration demand, that is, the original to-be-restored image includes an original image and a lost or damaged part (for example, an original mask). Alternatively, the original to-be-restored image includes an image with complete content that does not have an image restoration demand.

In a possible implementation, the original to-be-restored image is an image acquired from a photo that is taken by a camera of a terminal device; or the original to-be-restored image is an image acquired from inside of the terminal device. For example, the original to-be-restored image is an image stored in an album of the terminal device, or an image acquired by the terminal device from the cloud.

In step 202, mask detection is performed on the original to-be-restored image.

Mask detection is performed on the original to-be-restored image through a mask detection network to identify whether the original mask is present in the original to-be-restored image. In the case that the original mask is present in the original to-be-restored image, a position, a shape, and other information of the original mask in the original image are detected through the mask detection network. In the case that the original mask is not present in the original to-be-restored image, indicating that the original to-be-restored image has good clarity and integrity, the original to-be-restored image is directly output as a restored image.

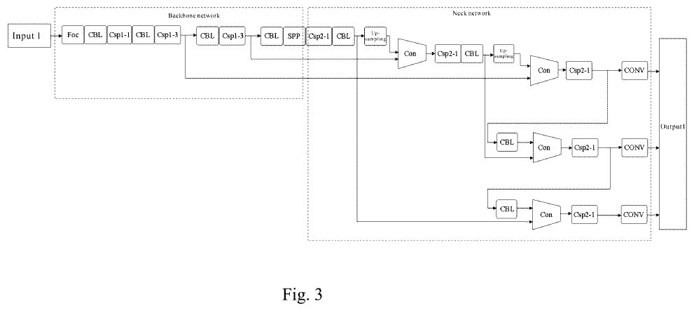

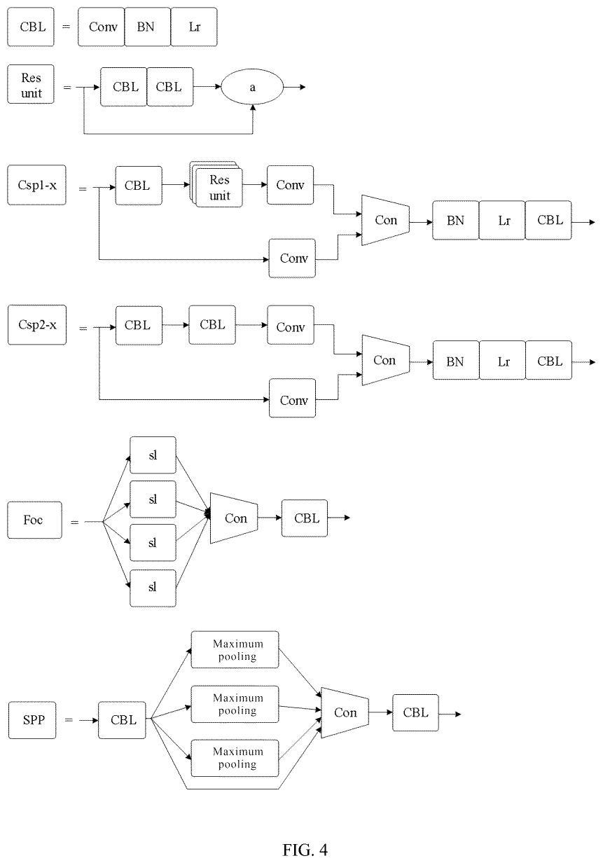

The mask detection network includes a YOLOv5 detection network. As a YOLO series algorithm has a simple structure and a high computation speed, the YOLO series algorithm is widely applied to a detection-related image processing process. As shown in FIG. 3 and FIG. 4, FIG. 3 is a schematic diagram of a network structure of a mask detection network according to some embodiments of the present disclosure, and FIG. 4 is a schematic diagram of a network structure of a part of modules in the mask detection network shown in FIG. 3. It can be seen from FIG. 3 that the YOLOv5 detection network includes an input end, a backbone network, a neck network, and an output end.

Foc (Focus) represents a focus network, defined to reduce a calculation amount of the YOLOv5 detection network and improve a calculation speed. Conv represents a convolutional layer. Con (Concat) represents a merging or permutation operation of matrices. Lr (Leaky relu) represents an activation function. CBL consists of the convolutional layer (Conv), Batch Normalization (BN), and the activation function (Leaky relu). The BN is also referred to as normalized batch. SPP consists of a plurality of pooling layers (maxpool) and Concat. CSP1-x represents a first detection network, where x is 1, 2, 3, and the like. CSP2-x represents a second detection network, where x is 1, 2, 3, and the like. Res unit represents a residual component. a (add) represents an addition operation of matrices. sl (slice) represents a data slice.

For example, a Focus layer in FIG. 4 splits an image (feature map) with a high resolution into a plurality of images (feature maps) with a low resolution through a data slicing operation, that is, samples an image with a high resolution every other column and then merges the sampled images. For example, an original image of 640×640×3 is input into the Focus layer, and the image is split into four parts through data slicing. That is, the image is processed into a feature map of 320×320×12, the feature map is merged (Concat), and convolution (CBL) processing is performed on the feature map, finally a feature map of 320×320×64 is acquired. Information loss is reduced by processing the feature map through the Focus layer.

An SPP layer in FIG. 4 performs maximum pooling processing on the same image through a plurality of pooling kernels to acquire a plurality of feature maps, and then fuses the plurality of feature maps and a feature map on which the maximum pooling processing is not performed. Any two of the plurality of pooling kernels have different sizes. The SPP layer fuses features with different sizes, such that the mask detection network is applicable to a case in which masks in the original to-be-restored image have greatly different sizes.

The mask detection network is a pre-trained neural network. Training data includes a sample image and a mask image. The mask image refers to an image that covers a mask on the sample image. For example, the sample image refers to an image with high definition and complete image content in a sample data set. The mask image refers to an image covering masks of different shapes on the sample image. It should be noted that the mask detection network in the embodiments of the present disclosure may be other detection networks, such as a YOLOv4 detection network.

In step 203, an original mask feature map of the original to-be-restored image is acquired in response to detecting an original mask in the original to-be-restored image.

In the case that the original mask is present in the original to-be-restored image, the original mask feature map is output through the mask detection network. Specifically, a pixel value of a pixel point in an original mask area in the original to-be-restored image is set to 0, and a pixel value of a pixel point outside the original mask area in the original to-be-restored image is set to 1, where an area outside the original mask area is referred to as an original image area to acquire the original mask feature map. The original mask feature map is a matrix, and the matrix includes 0 and 1.

In step 204, a target area is acquired.

The target area includes the pixel point of the original mask in the original mask feature map.

A plurality of original masks are present in the original mask feature map, and the area in which the pixel point of each original mask in the original mask feature map is located is separately acquired. For example, a coordinate system is established based on the original mask feature map, coordinates of pixel points of the plurality of original masks in the original mask feature map are acquired, and then the target area in which the pixel points of the plurality of original masks are located is acquired.

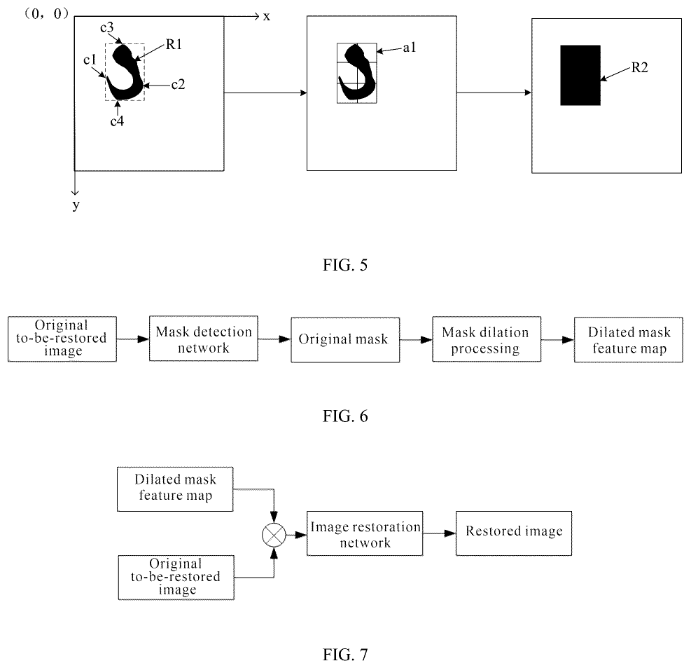

For example, as shown in FIG. 5, FIG. 5 is a schematic diagram of a structure of traversing a target area by a detection box according to some embodiments of the present disclosure. The original mask feature map is a rectangle. A two-dimensional coordinate system (x, y) is established by taking one vertex of the original mask feature map as origin (0, 0), and coordinates of a plurality of pixel points in an original mask R1 are acquired to acquire a first pixel point c1, a second pixel point c2, and a third pixel point c3 in the original mask R1. An x-coordinate value of the first pixel point c1 and an x-coordinate value of the second pixel point c2 are respectively the maximum value and the minimum value of x-coordinate values of the plurality of pixel points in the original mask. A y-coordinate value of the third pixel point c3 and a y-coordinate value of the fourth pixel point c4 are respectively the maximum value and the minimum value of y-coordinate values of the plurality of pixel points in the original mask R1. That is, four vertexes of the original mask R1 in an x direction and a y direction are acquired, and the target area in which the pixel point of the original mask R1 in the original mask feature map is located is acquired based on the four vertexes.

In step 205, the target area is traversed by a detection box.

The detection box is defined to detect whether the pixel point of the original mask is present in the detection box in the process of traversing the target area. In some embodiments, the detection box is a rectangular detection box.

In some embodiments, a detection box al is a square detection box. A moving step length during traversal of the detection box al is equal to a side length. In this way, detection efficiency of the detection box is improved. For example, referring to FIG. 5, the side length of the detection box is 4, and the moving step length during traversal is also 4.

In step 206, a plurality of pixel points in the detection box are processed into a mask unit in response to detecting that the pixel point of the original mask is present in the detection box to acquire a dilated mask feature map, where a pixel value of the pixel point in the mask unit is a preset value.

Referring to FIG. 6, FIG. 6 is a network architecture diagram of processing an original mask into a dilated mask according to some embodiments of the present disclosure. In this way, the original mask in the original mask feature map is processed into the dilated mask, and an irregular original mask is processed into a regular dilated mask to acquire the dilated mask feature map. The dilated mask includes at least one mask unit, and the original mask is located in an area in which the at least one mask unit is located. In some embodiments, the mask unit is a rectangular mask unit, which improves regularity of a shape of the dilated mask.

For example, referring to FIG. 5, the preset value is 0. In a case that the pixel point of the original mask is detected in the detection box, all the pixel values of the plurality of pixel points in the detection box are assigned 0, that is, the pixel value of the pixel point in the mask unit is 0 to acquire a dilated mask R2 corresponding to the original mask R1, and then acquire the dilated mask feature map.

In step 207, the dilated mask in the dilated mask feature map is overlaid at the location of the original mask in the original to-be-restored image to acquire a mask enhancement feature map.

The dilated mask feature map is multiplied by the original to-be-restored image to acquire the mask enhancement feature map. As the preset value is 0, the pixel value of the pixel point of the dilated mask in the dilated mask feature map is also 0. Therefore, the pixel value of the pixel point of the dilated mask in the mask enhancement feature map is 0.

For example, the dilated mask feature map is a matrix including 0 and 1, and the original to-be-restored image is a matrix including a plurality of pixel values (e.g., 5, 8, and 20). After the dilated mask feature map is multiplied by the original to-be-restored image, a pixel value of a pixel point multiplied by 0 in the original to-be-restored image is 0, and a pixel value of a pixel point multiplied by 1 in the original to-be-restored image is unchanged. This is equivalent to that the dilated mask in the dilated mask feature map is overlaid at the location of the original mask in the original to-be-restored image, and pixel values of pixel points at the location of the dilated mask are all 0.

In step 208, an image restoration network is acquired.

The image restoration network is a trained fusion network. The image restoration network includes a plurality of convolutional layers and a plurality of FFGs. The plurality of FFGs are defined to fuse an original image feature and a dilated mask feature to fill the dilated mask in the mask enhancement feature map.

That is, the original image feature and the dilated mask feature in the mask enhancement feature map are fused through the image restoration network to restore the dilated mask in the mask enhancement feature map and acquire a restoration feature map. The plurality of FFGs are acquired by training.

In step 209, the mask enhancement feature map is input into the image restoration network, and the original image feature and the dilated mask feature in the mask enhancement feature map are fused through the image restoration network to restore the dilated mask in the mask enhancement feature map and acquire the restoration feature map.

Referring to FIG. 7, FIG. 7 is a network architecture diagram of image restoration according to some embodiments of the present disclosure. The image restoration network is a network acquired by training based on a sample mask feature map including the dilated mask. In some embodiments, the mask enhancement feature map includes the dilated mask feature and the original image feature except an area in which the dilated mask feature is located.

As a texture feature of the original mask in the original mask feature map is fine, complex and irregular, the image restoration network in the related art has low precision of restoring a complex original mask, and generated filling content of the original mask is not accurate, as a result, a part of the original masks with small sizes or complex textures are not completely restored. In addition, in the related art, the image restoration network is trained based on a sample mask image including the original mask. As the texture of the original mask is complex and changeable, a difficulty of training the image restoration network is large.

In the embodiments of the present disclosure, the image restoration network is trained through the sample mask feature map including the dilated mask. In the process of restoring the original to-be-restored image, first, the original mask in the original mask feature map is processed into the dilated mask through mask detection and mask dilation to acquire the dilated mask feature map; then, the dilated mask in the dilated mask feature map is overlaid at the location of the original mask in the original to-be-restored image to acquire the mask enhancement feature map. In this way, compared with the original mask, the dilated mask in the mask enhancement feature map has a simple and regular texture feature, which reduces the image restoration difficulty. In addition, the image restoration network in the embodiments of the present disclosure is acquired by training based on the sample mask feature map including the dilated mask. The texture of the dilated mask is simple, such that the difficulty of training the image restoration network is small. Furthermore, adaptability between the original to-be-restored image and the image restoration network is improved by processing the original mask into the dilated mask, and meanwhile, universal applicability of the image restoration network is also improved.

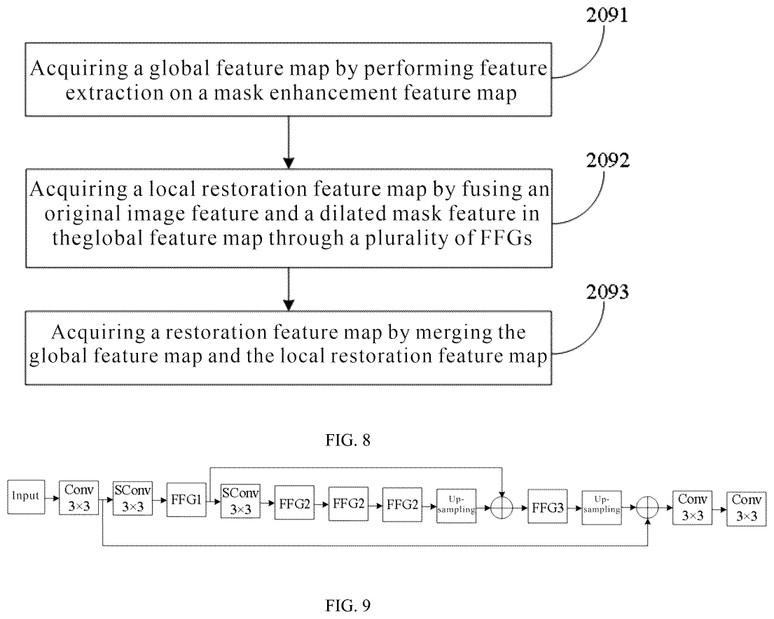

As shown in FIG. 8, step 209 includes the following three sub-steps.

In sub-step 2091, feature extraction is performed on the mask enhancement feature map to acquire a global feature map.

The feature extraction is down-sampling and other manners. In an optional embodiment:

Down-sampling is performed on the mask enhancement feature map, which reduces a dimension of the mask enhancement feature map and retains valid information, and prevents an over-fitting phenomenon.

In sub-step 2092, the original image feature and the dilated mask feature in the global feature map are fused through the plurality of FFGs to acquire a local restoration feature map.

Referring to FIG. 9, FIG. 9 is a schematic diagram of a network structure of an image restoration network according to some embodiments of the present disclosure. In some embodiments, the plurality of FFGs include a first FFG (FFG1), a plurality of second FFGs (FFG2), and a third FFG (FFG3). Each of the first FFG (FFG1), the plurality of second FFGs (FFG2), and the third FFG (FFG3) includes a plurality of MABs. The MAB is also acquired by training. Conv represents a convolutional layer. SConv represents stride convolution. A step length of the stride convolution is 2, that is, the image feature map is reduced by 2 times after the stride convolution is performed. In a subsequent image processing process, the image feature map is restored through up-sampling.

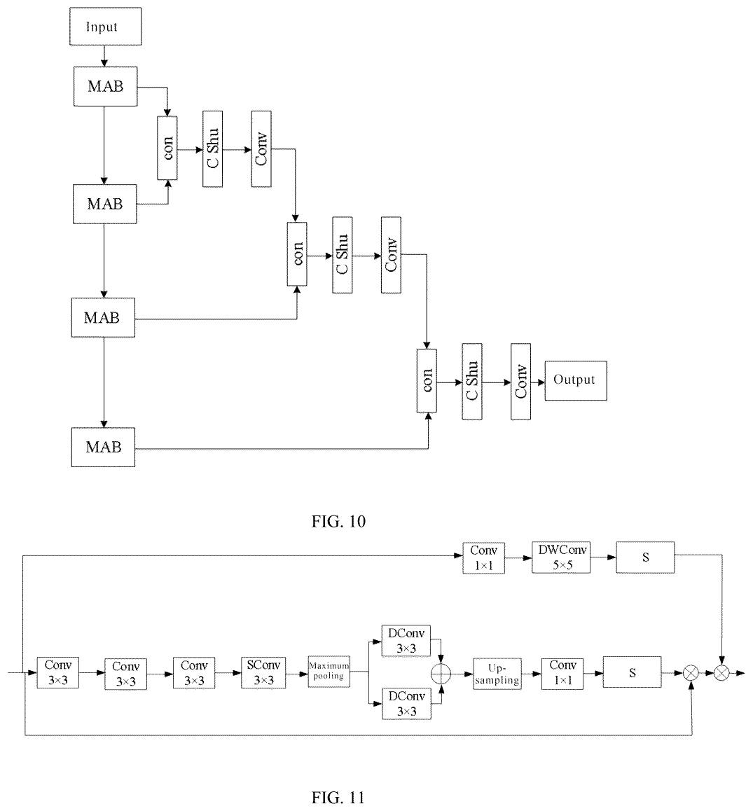

Referring to FIG. 10, FIG. 10 is a schematic diagram of a network structure of an FFG according to some embodiments of the present disclosure. The first FFG, the plurality of second FFGs, and the third FFG have a same structure, and are all referred to as an FFG. The FFG includes a plurality of MABs. Conv represents a convolutional layer. Con represents a merging or permutation operation of matrices. C Shu represents Channel Shuffle, defined to mix information between connection channels. The convolutional layer is a convolutional layer of 1×1, and the convolutional layer of 1×1 is defined to reduce a channel of a feature map.

Referring to FIG. 11, FIG. 11 is a schematic diagram of a network structure of an MAB according to some embodiments of the present disclosure. Conv represents a convolutional layer. SConv represents stride convolution. Concat represents a merging or permutation operation of matrices. DConv represents dilated convolution. DWConv represents deep convolution. S represents a Sigmoid activation function. The Sigmoid activation function is a logic activation function, also referred to as a sigmoid growth curve. The Sigmoid function is used as an activation function of a neural network to map a variable to [0, 1]. An initially extracted feature map is input into the MAB for different processing in three branches. A top branch includes one 1×1 convolution, one 5×5 depth-separable convolution, and one Sigmoid activation function. A middle branch includes: first, two 3×3 convolutions and one 1×1 convolution, one 3×3 convolution with a step length of 2, maximum pooling; then, two parallel 3×3 depth-separable convolutions, and up-sampling after addition; at last, one 1×1 convolution and one Sigmoid activation function. A bottom branch is actually connecting a jump to and multiplying the jump by an output of the middle branch, and then multiplying a result of multiplication by an output of the top branch to acquire a final output. The Sigmoid activation function maps a variable to an interval (0, 1). Data does not diverge easily in a transmission process. The dilated convolution dilates a receptive field, which helps to restore image detail loss caused by supersaturated areas and motion dislocation. It should be noted that a structure of the MAB in the embodiments of the present disclosure is the MAB shown in FIG. 11, or an MAB of another structure, which is not limited in the embodiments of the present disclosure.

In a process of fusing the original image feature and the dilated mask feature in the mask enhancement feature map, the MAB is introduced into an image restoration work. The MAB not only uses information around the area in which the dilated mask is located, but also enhances and uses a feature which is beneficial to restoration in global information of the whole image, such that structures and textures in the restored image are clearer and more coherent.

In an exemplary implementation, referring to FIG. 11, the MAB includes a first image enhancement network and a second image enhancement network. Processing an image through the MAB includes the following steps.
1) A to-be-processed image is input into the MAB.

The to-be-processed image is an image feature that is input into the MAB in a process of processing an image through a feature network in the embodiments of the present disclosure. As the image restoration network includes a plurality of MABs, the to-be-processed image is different image features, but does not refer to the to-be-processed image in a certain MAB. The MAB includes the first image enhancement network and the second image enhancement network.
2) The to-be-processed image is input into the first image enhancement network to acquire a first enhanced image.

The first image enhancement network includes a plurality of convolutional layers, a plurality of depth-separable convolutional layers, and a pooling layer. The first image enhancement network is defined to dilate a receptive field of the to-be-processed image. After the to-be-processed image is input into the MAB, the to-be-processed image is input into the first image enhancement network of the MAB to process the image through the first image enhancement network and acquire the first enhanced image.
3) The to-be-processed image passes through the second image enhancement network to acquire a second enhanced image.

The second image enhancement network includes one convolutional layer and one depth-separable convolutional layer. The second image enhancement network is defined to dilate the receptive field of the to-be-processed image. A receptive field dilation capability of the first image enhancement network is stronger than that of the second image enhancement network. After the to-be-processed image is input into the MAB, the to-be-processed image is input into the second image enhancement network of the MAB to process the image through the second image enhancement network and acquire the first enhanced image.
4) Feature fusion is performed on the first enhanced image and the to-be-processed image to acquire a first intermediate image.

The MAB fuses the first enhanced image acquired through the first image enhancement network and the to-be-processed image that is not processed by the MAB to enrich details of the first intermediate image.
5) Feature fusion is performed on the first intermediate image and the second enhanced image to acquire a feature-enhanced image.

The MAB fuses the second enhanced image acquired through the second image enhancement network and the first intermediate image to enrich details of the first intermediate image. In this way, information from different convolutional layers is fully utilized, such that more details are retained in the acquired feature-enhanced image. This helps to restore details of a mask area in the to-be-processed image.

The foregoing method for restoring an image through the MAB is applicable to the process of fusing the original image feature and the dilated mask feature in the mask enhancement feature map in the embodiments of the present disclosure, that is, is applicable to each of the plurality of FFGs. As shown in FIG. 10, the feature-enhanced image is an output result of any MAB in the FFGs.

Further, in an embodiment of the present disclosure, that the original image feature and the dilated mask feature in the global feature map are fused through the plurality of FFGs to acquire the local restoration feature includes the following steps.
1) Down-sampling is performed on the global feature map to acquire a first feature map.

A feature, which is beneficial to restoring the dilated mask, in the global feature map is extracted to acquire the first feature map.
2) The dilated mask feature and the original image feature in the first feature map are fused through the first FFG to acquire a second feature map.

The first FFG performs first fusion on the dilated mask feature and the original image feature. Emphases of multiple FFGs are different in fusing the dilated mask feature and the original image feature. For example, the first FFG places emphasis on restoring a color of the area in which the dilated mask is located.
3) Down-sampling is performed on the second feature map to acquire a third feature map.
4) The dilated mask feature and the original image feature in the third feature map are fused many times through the plurality of second FFGs to acquire a fourth feature map.

The plurality of FFGs perform the second fusion on the dilated mask feature and the original image feature. For example, the second FFG places emphasis on restoring the texture of the area in which the dilated mask is located.
5) Up-sampling is performed on the fourth feature map to acquire a fifth feature map.

The up-sampling includes an image processing manner of pixel shuffle.
6) The first feature map and the fifth feature map are merged and input into the third FFG to acquire a sixth feature map.

The image feature maps that are fused by the FFGs having different emphases are merged, and the dilated mask feature and the original image feature are fused again through the third FFG to enrich details in a fused image feature.

It should be noted that, both the first feature map and the fifth feature map in the embodiments of the present disclosure are essentially a matrix. In the embodiments of the present disclosure, the merging of the first feature map and the fifth feature map is essentially the merging of two matrices, which is a process of arranging or merging two matrices on the premise of not changing the order of the two matrices.
7) Up-sampling is performed on the sixth feature map to acquire a local restoration feature map.

In sub-step 2093, the global feature map and the local restoration feature map are merged to acquire a restoration feature map.

The foregoing global feature map and local restoration feature map are merged, such that the restoration feature map has more image details. Such an image restoration network can pay attention to both a local feature and a global feature in the original to-be-restored image, which improves the restoration performance of the network.

In step 210, dimension transformation is performed on the restoration feature map to acquire a restored image corresponding to the original to-be-restored image.

The dimension transformation is up-sampling or down-sampling, and other manners. In an optional embodiment:

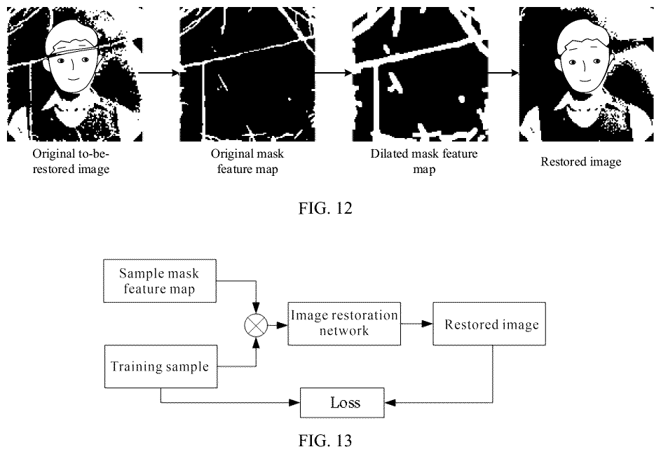

Redundant information is present in the restoration feature map. A combination of two 3×3 convolutions and one activation function is used to perform dimension reduction on an important feature map to acquire the restored image corresponding to the original to-be-restored image. As shown in FIG. 12, FIG. 12 is a schematic diagram of an image restoration process according to some embodiments of the present disclosure. In the embodiments of the present disclosure, an original mask in an original to-be-restored image is processed into a dilated mask, and the dilated mask is overlaid at the location of the original mask in the original to-be-restored image to acquire a mask enhancement feature map; then the dilated mask in the mask enhancement feature map is restored using an image restoration network to acquire a restored image corresponding to the original to-be-restored image. In addition, an image restoration network with a strong restoration capability and good universal applicability is acquired by training the image restoration network based on the sample mask feature map including the dilated mask. Using the image restoration network to restore an image, the restoration efficiency is high and the restoration effect is good.

It should be noted that the foregoing steps are merely defined to explain the embodiments of the present disclosure, and those skilled in the art can delete the foregoing steps. It should be noted that the serial numbers of the operations in the foregoing method are merely defined to represent the operations for description, and should not be taken to represent a sequence of performing the operations. Unless explicitly stated, the method does not need to be performed in exactly the shown sequence.

In summary, the embodiments of the present disclosure provide an image restoration method. An original mask in an original to-be-restored image is processed into a dilated mask with a regular shape, and the dilated mask is overlaid at the location of the original mask in the original to-be-restored image to acquire a mask enhancement feature map; then the dilated mask in the mask enhancement feature map is restored using an image restoration network to acquire a restored image corresponding to the original to-be-restored image. As the shape of the dilated mask is regular, the effect of restoring the mask in the original image is improved, the problem of a poor restoration effect of the restored image in the related art is solved, thereby improving the restoration effect of the restored image.

In some embodiments, the image restoration network in step 208 is an image restoration network trained in advance, or the image restoration network is trained in step 208. It should be noted that the networks (the mask detection network, the first FFG, the plurality of second FFGs, the third FFG, and the MAB) applied in the embodiments of the present disclosure are all trained network structures. The networks are trained through deep learning. The deep learning is a method of machine learning. The embodiments of the present disclosure do not limit the training manner of these networks.

Referring to FIG. 13, FIG. 13 is a network architecture diagram of training an image restoration network according to some embodiments of the present disclosure. In the training of the image restoration network, a sample mask feature map and a training sample are multiplied as an input, and the training sample is taken as a true value. In a training process, the training sample is randomly extracted from a sample database and then input into a fusion network for training. A network optimizer includes an Adam optimizer. An initial learning rate is 1e-4. A loss function of the image restoration network includes:

$$Loss = {‖ \hat{I} - {I}_{gt} ‖}_{1}$$

where Loss represents a comparison difference, Î represents a restored image corresponding to the training sample, and I_{gt} represents the training sample.

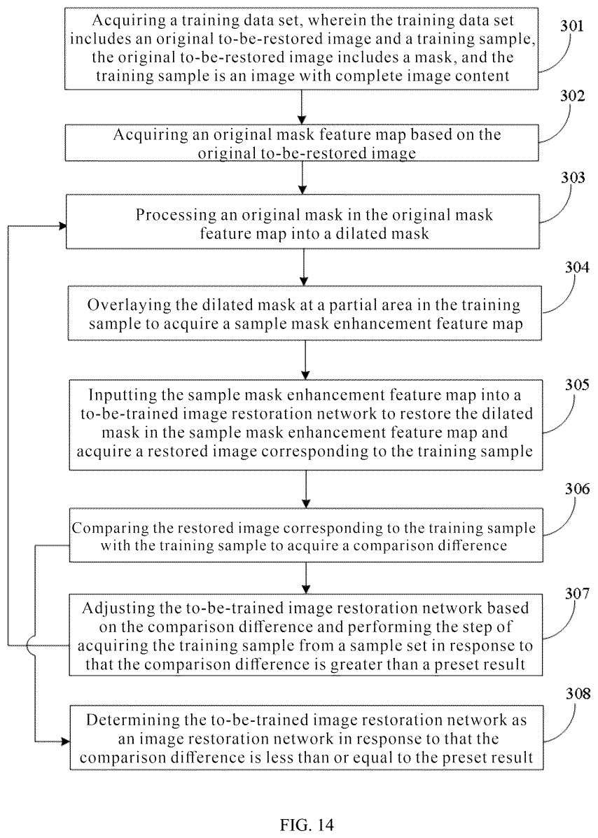

As shown in FIG. 14, in the embodiments of the present disclosure, a method for training the image restoration network includes the following steps.

In step 301, a training data set is acquired, where the training data set includes an original to-be-restored image and a training sample, the original to-be-restored image includes a mask, and the training sample is an image with complete image content.

The training data set includes a plurality of training samples. The training sample is an image with high definition and complete image content.

In some embodiments, a dilated mask sample includes a plurality of dilated masks, and sizes of any two of the plurality of dilated masks are different. The plurality of dilated masks in the dilated mask sample are randomly generated rectangular dilated masks. As the original mask in the to-be-stored image is usually a line or strip, the rectangular dilated mask is highly matched to the original mask. Meanwhile, compared with the irregular original mask, the difficulty of restoring the rectangular dilated mask is smaller.

In step 302, an original mask feature map is acquired based on the original to-be-restored image.

In the case that the original mask is present in the original to-be-restored image, the original mask feature map is output through the mask detection network.

In step 303, the original mask in the original mask feature map is processed into the dilated mask.

A target area is traversed by a detection box to acquire the dilated mask. The target area includes a pixel point of the original mask in the original mask feature map.

In step 304, the dilated mask is overlaid at a partial area in the training sample to acquire a sample mask enhancement feature map.

The sample mask feature map is multiplied by the training sample to acquire a sample mask enhancement feature map. A pixel value of a pixel point of the dilated mask in the dilated mask sample is 0. Therefore, a pixel value of a pixel point of the dilated mask in the sample mask enhancement feature map is 0.

For example, the sample mask feature map is a matrix including 0 and 1, the training sample is a matrix including a plurality of pixel values (e.g., 5, 8, and 20). After the sample mask feature map is multiplied by the training sample, a pixel value of a pixel point multiplied by 0 in the training sample is 0, and a pixel value of a pixel point multiplied by 1 in the training sample is unchanged. This is equivalent to that the dilated mask in the sample mask feature map is overlaid at the location of the original mask in the training sample, and pixel values of pixel points at the location of the dilated mask are all 0.

In step 305, the sample mask enhancement feature map is input into a to-be-trained image restoration network to restore the dilated mask in the sample mask enhancement feature map and acquire a restored image corresponding to the training sample.

The image restoration network is trained through the sample mask feature map including the dilated mask. In the process of training a sample, compared with the original mask in the related art, the dilated mask has simple and regular texture feature, which reduces the image restoration difficulty. In addition, the image restoration network in the embodiments of the present disclosure is acquired by training based on the sample mask feature map including the dilated mask. The texture of the dilated mask is simple, such that the difficulty of training the image restoration network is small. Furthermore, in a subsequent image restoration process, adaptability between the original to-be-restored image and the image restoration network is improved by processing the original mask into the dilated mask, and meanwhile, universal applicability of the image restoration network is also improved.

In step 306, the restored image corresponding to the training sample is compared with the training sample to acquire a comparison difference.

The comparison difference is defined to represent a degree of difference between the restored image and the training sample.

In step 307, the to-be-trained image restoration network is adjusted based on the comparison difference and the step of processing the original mask in the original mask feature map into the dilated mask is performed in response to that the comparison difference is greater than a preset result.

In a case that the difference between the acquired restored image and the training sample is large, it indicates that a parameter in the image restoration network is not accurate enough, and the parameter in the image restoration network is further adjusted by training many times. That is, after step 307, steps 301, 302 or 303 are performed.

In step 308, the to-be-trained image restoration network is determined as the image restoration network in response to that the comparison difference is less than or equal to the preset result.

In the case that the difference between the acquired restored image and the training sample is small, it indicates that the parameter in the image restoration network is accurate, and the training of the image restoration network is finished.

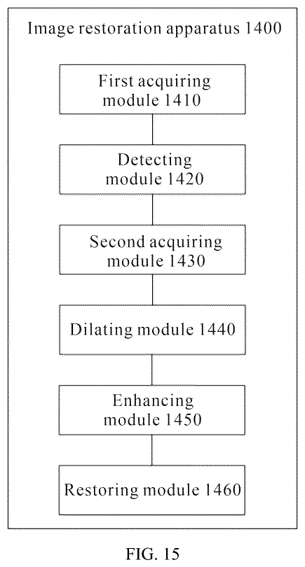

FIG. 15 is a structural block diagram of an image restoration apparatus according to some embodiments of the present disclosure. The image restoration apparatus 1400 includes:
a first acquiring module 1410, configured to acquire an original to-be-restored image;
a detecting module 1420, configured to perform mask detection on the original to-be-restored image;
a second acquiring module 1430, configured to acquire an original mask feature map of the original to-be-restored image in response to detecting an original mask in the original to-be-restored image;
a dilating module 1440, configured to acquire a dilated mask feature map by processing the original mask in the original mask feature map into a dilated mask, where the dilated mask includes at least one mask unit, and the original mask is located in an area in which the at least one mask unit is located;
an enhancing module 1450, configured to acquire a mask enhancement feature map by overlaying the dilated mask in the dilated mask feature map at the location of the original mask in the original to-be-restored image; and
a restoring module 1460, configured to acquire a restored image corresponding to the original to-be-restored image by inputting the mask enhancement feature map into an image restoration network to restore the dilated mask in the mask enhancement feature map. The image restoration network is acquired by training based on a sample mask feature map including the dilated mask.

In some embodiments, the dilating module includes:
a third acquiring module, configured to acquire a target area, where the target area includes a pixel point of the original mask in the original mask feature map;
a traversing module, configured to traverse the target area by a detection box; and
a pixel processing module, configured to acquire the dilated mask feature map by processing a plurality of pixel points in the detection box into the mask unit in response to detecting that the pixel point of the original mask is present in the detection box, where a pixel value of the pixel point in the mask unit is a preset value.

In some embodiments, the restoring module is configured to:
acquire a restoration feature map by fusing the original image feature and the dilated mask feature in the mask enhancement feature map through the image restoration network to restore the dilated mask in the mask enhancement feature map.

In summary, the embodiments of the present disclosure provide an image restoration apparatus. An original mask in an original to-be-restored image is processed into a dilated mask with a regular shape, and the dilated mask is overlaid at the location of the original mask in the original to-be-restored image to acquire a mask enhancement feature map; then the dilated mask in the mask enhancement feature map is restored using an image restoration network to acquire a restored image corresponding to the original to-be-restored image. As the shape of the dilated mask is regular, the effect of restoring the mask in the original image is improved, the problem of a poor restoration effect of the restored image in the related art is solved, thereby improving.

In addition, the embodiments of the present disclosure further provides a schematic diagram of a structure of an electronic device. The electronic device includes one or more processors, an image shooting assembly, a memory, and a terminal. The memory includes a random access memory (RAM) and a read only memory (ROM). The image shooting assembly is integrated with the terminal. The part related to network training in the foregoing image restoration method is applicable to a server, and other parts related to image processing except the network training is applicable to both the server and the terminal.

Furthermore, the embodiments of the present disclosure further provides an image restoration device. The image restoration device includes a processor and a memory. The memory stores at least one instruction, at least one program, a code set, or an instruction set thereon. Wherein the processor, when loading and executing the at least one instruction, the at least one program, the code set, or the instruction set, is caused to perform the image restoration method in any one of the foregoing embodiments.

In addition, the embodiments of the present disclosure further provides a non-transitory computer storage medium. The non-transitory computer storage medium stores at least one instruction, at least one program, a code set, or an instruction set thereon. The at least one instruction, the at least one program, the code set, or the instruction set, when loaded and executed by a processor, causes the processor to perform the image restoration method in any one of the foregoing embodiments.

In addition, the embodiments of the present disclosure further provides a computer program product or a computer program. The computer program product or the computer program includes computer instructions. The computer instructions are stored in a computer-readable storage medium. A processor of a computer device reads the computer instructions from the computer-readable storage medium, and executes the computer instructions, such that the computer device performs the image restoration method in any one of the foregoing embodiments.

In the present disclosure, the terms “first”, “second”, “third”, and “fourth” are merely used for descriptive purposes and should not be construed as indicating or implying relative importance. The term “a plurality of” refers to two or more, unless otherwise explicitly defined.

In the several embodiments provided in the present disclosure, it should be understood that the disclosed apparatus and method may be implemented in other manners. For example, the described apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be disposed at one position, or may be distributed on a plurality of network units. A part or all of the units may be selected based on actual requirements to achieve the objectives of the solutions of embodiments.

It will be appreciated by those of ordinary skill in the art that all or a part of the steps for implementing the foregoing embodiments may be completed by hardware, or may be completed by instructing relevant hardware by a program stored in a computer-readable storage medium. The storage medium mentioned above may be a read-only memory, a magnetic disk, an optical disk, or the like.

Described above are merely optional embodiments of the present disclosure and are not intended to limit the present disclosure. Any modifications, equivalents, improvements, and the like, made within the spirit and principle of the present disclosure should fall within the protection scope of the present disclosure.

1. An image restoration method, comprising:
acquiring an original to-be-restored image;
performing mask detection on the original to-be-restored image;
acquiring an original mask feature map of the original to-be-restored image in response to detecting an original mask in the original to-be-restored image;
acquiring a dilated mask feature map by processing the original mask in the original mask feature map into a dilated mask, wherein the dilated mask comprises at least one mask unit, and the original mask is located in an area in which the at least one mask unit is located;
acquiring a mask enhancement feature map by overlaying the dilated mask in the dilated mask feature map at a location of the original mask in the original to-be-restored image; and
acquiring a restored image corresponding to the original to-be-restored image by inputting the mask enhancement feature map into an image restoration network to restore the dilated mask in the mask enhancement feature map.

2. The image restoration method according to claim 1, wherein acquiring the dilated mask feature map by processing the original mask in the original mask feature map into the dilated mask comprises:
acquiring a target area, wherein the target area comprises a pixel point of the original mask in the original mask feature map;
traversing the target area by a detection box; and
acquiring the dilated mask feature map by processing a plurality of pixel points in the detection box into the mask unit in response to detecting that the pixel point of the original mask is present in the detection box, wherein a pixel value of the pixel point in the mask unit is a preset value.

3. The image restoration method according to claim 2, wherein the detection box is a square detection box, and a moving step length during traversal of the detection box is equal to a side length.

4. The image restoration method according to claim 1, wherein the mask enhancement feature map comprises a dilated mask feature and an original image feature except an area in which the dilated mask feature is located;
acquiring the restored image corresponding to the original to-be-restored image by inputting the mask enhancement feature map into the image restoration network to restore the dilated mask in the mask enhancement feature map comprises:
acquiring a restoration feature map by fusing the original image feature and the dilated mask feature in the mask enhancement feature map through the image restoration network to restore the dilated mask in the mask enhancement feature map.

5. The image restoration method according to claim 4, wherein after acquiring the restoration feature map, the image restoration method comprises:
performing dimension transformation on the restoration feature map to acquire the restored image corresponding to the original to-be-restored image.

6. The image restoration method according to claim 4, wherein the image restoration network comprises a plurality of feature fusion groups (FFG);
acquiring a restoration feature map by fusing the original image feature and the dilated mask feature in the mask enhancement feature map through the image restoration network to restore the dilated mask in the mask enhancement feature map comprises:
performing feature extraction on the mask enhancement feature map to acquire a global feature map;
acquiring a local restoration feature map by fusing the original image feature and the dilated mask feature in the global feature map through the plurality of FFGs; and
acquiring the restoration feature map by merging the global feature map and the local restoration feature map.

7. The image restoration method according to claim 6, wherein the plurality of FFGs comprise a first FFG, a plurality of second FFGs, and a third FFG; each of the first FFG, the plurality of second FFGs, and the third FFG comprises a plurality of multi-attention blocks (MAB);
acquiring the local restoration feature map by fusing the original image feature and the dilated mask feature in the global feature map through the plurality of FFGs comprises:
acquiring a first feature map by performing down-sampling on the global feature map;
acquiring a second feature map by fusing the dilated mask feature and the original image feature in the first feature map through the first FFG;
acquiring a third feature map by performing down-sampling on the second feature map;
acquiring a fourth feature map by fusing the dilated mask feature and the original image feature in the third feature map many times through the plurality of second FFGs;
acquiring a fifth feature map by performing up-sampling on the fourth feature map;
acquiring a sixth feature map by merging the first feature map and the fifth feature map and inputting the merged first feature map and fifth feature map into the third FFG; and
acquiring the local restoration feature map by performing up-sampling on the sixth feature map.

8. The image restoration method according to claim 7, wherein the MAB comprises a first image enhancement network and a second image enhancement network; the image restoration method further comprises:
inputting a to-be-processed image into the MAB;
acquiring a first enhanced image by inputting the to-be-processed image into the first image enhancement network;
acquiring a second enhanced image by inputting the to-be-processed image into the second image enhancement network;
acquiring a first intermediate image by performing feature fusion on the first enhanced image and the to-be-processed image; and
acquiring a feature-enhanced image by performing feature fusion on the first intermediate image and the second enhanced image;
wherein the first image enhancement network comprises a plurality of convolutional layers, a plurality of depth-separable convolutional layers, and a pooling layer;
the second image enhancement network comprises one convolutional layer and one depth-separable convolutional layer; and
the first image enhancement network and the second image enhancement network are defined to dilate a receptive field of the to-be-processed image, wherein a receptive field dilation capability of the first image enhancement network is stronger than that of the second image enhancement network.

9. The image restoration method according to claim 1, wherein the image restoration network is trained by;
acquiring a training data set, wherein the training data set comprises an original to-be-restored image and a training sample, the original to-be-restored image is provided with a mask, and the training sample is an image with complete image content;
processing the original mask in the original mask feature map into the dilated mask;
overlaying the dilated mask at a partial area in the training sample to acquire a sample mask enhancement feature map;
inputting the sample mask enhancement feature map into a to-be-trained image restoration network to restore the dilated mask in the sample mask enhancement feature map and acquire a restored image corresponding to the training sample;
comparing the restored image corresponding to the training sample with the training sample to acquire a comparison difference;
adjusting the to-be-trained image restoration network based on the comparison difference and performing the step of processing the original mask in the original mask feature map into the dilated mask in response to that the comparison difference is greater than a preset result; and
determining the to-be-trained image restoration network as the image restoration network in response to that the comparison difference is less than or equal to the preset result.

10. The image restoration method according to claim 9, wherein the dilated mask sample comprises a plurality of the dilated masks, and sizes of any two of the plurality of dilated masks are different.

11. The image restoration method according to claim 9, wherein a loss function of the image restoration network comprises:
$$Loss = {‖ \hat{I} - {I}_{gt} ‖}_{1}$$
wherein Loss represents the comparison difference, Î represents the restored image corresponding to the training sample, and I_{gt} represents the training sample.

12. The image restoration method according to claim 2, wherein the preset value is 0;
acquiring a mask enhancement feature map by overlaying the dilated mask in the dilated mask feature map at the location of the original mask in the original to-be-restored image comprises:
acquiring the mask enhancement feature map by multiplying the dilated mask feature map by the original to-be-restored image, wherein a pixel value of a pixel point of the dilated mask in the acquired mask enhancement feature map is 0.

13.-15. (canceled)

16. An image restoration device, comprising a processor and a memory storing at least one instruction, at least one program, a code set, or an instruction set thereon, wherein the processor, when loading and executing the at least one instruction, the at least one program, the code set, or the instruction set, is caused to perform:
acquiring an original to-be-restored image;
performing mask detection on the original to-be-restored image;
acquiring an original mask feature map of the original to-be-restored image in response to detecting an original mask in the original to-be-restored image;
acquiring a dilated mask feature map by processing the original mask in the original mask feature map into a dilated mask, wherein the dilated mask comprises at least one mask unit, and the original mask is located in an area in which the at least one mask unit is located;
acquiring a mask enhancement feature map by overlaying the dilated mask in the dilated mask feature map at a location of the original mask in the original to-be-restored image; and
acquiring a restored image corresponding to the original to-be-restored image by inputting the mask enhancement feature map into an image restoration network to restore the dilated mask in the mask enhancement feature map.

17. A non-transitory computer storage medium, storing at least one instruction, at least one program, a code set, or an instruction set thereon, wherein the at least one instruction, the at least one program, the code set, or the instruction set, when loaded and executed by a processor, causes the processor to perform:
acquiring an original to-be-restored image;
performing mask detection on the original to-be-restored image;
acquiring an original mask feature map of the original to-be-restored image in response to detecting an original mask in the original to-be-restored image;
acquiring a dilated mask feature map by processing the original mask in the original mask feature map into a dilated mask, wherein the dilated mask comprises at least one mask unit, and the original mask is located in an area in which the at least one mask unit is located;
acquiring a mask enhancement feature map by overlaying the dilated mask in the dilated mask feature map at a location of the original mask in the original to-be-restored image; and
acquiring a restored image corresponding to the original to-be-restored image by inputting the mask enhancement feature map into an image restoration network to restore the dilated mask in the mask enhancement feature map.

18. The image restoration device according to claim 16, wherein the processor, when loading and executing the at least one instruction, the at least one program, the code set, or the instruction set, is caused to perform:
acquiring a target area, wherein the target area comprises a pixel point of the original mask in the original mask feature map;
traversing the target area by a detection box; and
acquiring the dilated mask feature map by processing a plurality of pixel points in the detection box into the mask unit in response to detecting that the pixel point of the original mask is present in the detection box, wherein a pixel value of the pixel point in the mask unit is a preset value.

19. The image restoration device according to claim 18, wherein the detection box is a square detection box, and a moving step length during traversal of the detection box is equal to a side length.

20. The image restoration device according to claim 16, wherein the mask enhancement feature map comprises a dilated mask feature and an original image feature except an area in which the dilated mask feature is located; and
the processor, when loading and executing the at least one instruction, the at least one program, the code set, or the instruction set, is caused to perform:
acquiring a restoration feature map by fusing the original image feature and the dilated mask feature in the mask enhancement feature map through the image restoration network to restore the dilated mask in the mask enhancement feature map.

21. The image restoration device according to claim 20, wherein the processor, when loading and executing the at least one instruction, the at least one program, the code set, or the instruction set, is caused to perform:
performing dimension transformation on the restoration feature map to acquire the restored image corresponding to the original to-be-restored image.

22. The image restoration device according to claim 20, wherein the image restoration network comprises a plurality of feature fusion groups (FFG); and
the processor, when loading and executing the at least one instruction, the at least one program, the code set, or the instruction set, is caused to perform:
performing feature extraction on the mask enhancement feature map to acquire a global feature map;
acquiring a local restoration feature map by fusing the original image feature and the dilated mask feature in the global feature map through the plurality of FFGs; and
acquiring the restoration feature map by merging the global feature map and the local restoration feature map.

23. The image restoration device according to claim 18, wherein the preset value is 0; and
the processor, when loading and executing the at least one instruction, the at least one program, the code set, or the instruction set, is caused to perform:
acquiring the mask enhancement feature map by multiplying the dilated mask feature map by the original to-be-restored image, wherein a pixel value of a pixel point of the dilated mask in the acquired mask enhancement feature map is 0.
